(19) United States
(12) Patent Application Publication
(10) Pub. No.: US 2014/0120410 A1
(43) Pub. Date: May 1, 2014

(54) POSITIVE ELECTRODE FOR RECHARGEABLE LITHIUM BATTERY AND RECHARGEABLE LITHIUM BATTERY INCLUDING SAME

(71) Applicant: Samsung SDI Co., Ltd., Yongin-si (KR)

(72) Inventors: Jin-Man Jeoung, Yongin-si (KR); Kyeu-Yoon Sheem, Yongin-si (KR)

(73) Assignee: Samsung SDI Co., Ltd., Yongin-si (KR)

(21) Appl. No.: 14/024,545

(22) Filed: Sep. 11, 2013

Related U.S. Application Data
(60) Provisional application No. 61/721,353, filed on Nov. 1, 2012.

(51) Int. Cl. H01M 4/36

(52) U.S. Cl. CPC H01M 4/36
USPC 429/163; 429/211

(57) ABSTRACT

A positive electrode includes a current collector and a positive active mass layer on the current collector. The positive active mass layer includes a positive active material, active carbon, a conductive material, and a binder. The active mass density of the positive active mass layer and the thickness of the positive active mass layer satisfy Equation 1.

0.09≦active mass density of the active mass layer(g/cc)/thickness of the active mass layer(μm)≦0.3 Equation 1

### CROSS-REFERENCE TO RELATED APPLICATION

This application claims priority to and the benefit of U.S. Provisional Application No. 61/721,353, filed on Nov. 1, 2012 in the U.S. Patent and Trademark Office, the entire content of which is incorporated herein by reference.

### BACKGROUND

(a) Technical Field

This disclosure relates to a positive electrode for a rechargeable lithium battery and a rechargeable lithium battery including the same.

(b) Description of the Related Art

Recently, reductions in the size and weight of portable electronic equipment and the popularization of portable electronic devices has led to research into rechargeable lithium batteries having high energy density for use as power sources for such portable electronic devices.

A rechargeable lithium battery includes a negative electrode, a positive electrode, and an electrolyte, and generates electrical energy though oxidation and reduction reactions in the positive and negative electrodes resulting in the intercalation/deintercalation of lithium ions.

As the negative active material, rechargeable lithium batteries typically use lithium metal, carbon-based materials, Si, or the like.

As the positive active material, rechargeable lithium batteries typically use metal chalcogenide compounds capable of intercalating and deintercalating lithium ions, for example, composite metal oxides such as LiCoO₂, LiMn₂O₄, LiNiO₂, LiNi₁₋ₓCoₓO₂ (0<x<1), LiMnO₂.

Recently, rechargeable lithium batteries having good power characteristics have been actively investigated as batteries for vehicles.

### SUMMARY OF THE INVENTION

In an exemplary embodiment of the present invention, a positive electrode for a rechargeable lithium battery exhibits good high rate characteristics and cycle-life characteristics.

In another embodiment of the present invention, a rechargeable lithium battery includes the positive electrode.

According to embodiments of the present invention, a positive electrode for a rechargeable lithium battery includes a current collector and a positive active mass layer on the current collector. The positive active mass layer includes a positive active material, active carbon, a conductive material, and a binder. The positive active mass density of the positive active mass layer and the thickness of the positive active mass layer satisfy Equation 1, below.

0.02≦active mass density of the active mass layer(g/cc)/thickness of the active mass layer(μm)≦0.3 Equation 1

The ratio of the active mass density of the active mass layer (g/cc)/thickness (μm) of the active mass layer may be about 0.025 to about 0.3, as represented by Equation 2, below. In another embodiment, the ratio of the active mass density of the active mass layer (g/cc)/thickness (μm) of the active mass layer may be about 0.025 to about 0.2, as represented by Equation 3 below.

0.025≦active mass density of the active mass layer(g/cc)/thickness of the active mass layer(μm)≦0.3 Equation 2

0.025≦active mass density of the active mass layer(g/cc)/thickness of the active mass layer(μm)≦0.2 Equation 3

The active mass density of the active mass layer may be about 1.5 g/cc to about 4 g/cc. The thickness of the active mass layer may be about 10 μm to about 200 μm, and in another embodiment, the thickness may be about 30 μm to about 200 μm.

According to another embodiment, a rechargeable lithium battery includes the positive electrode, a negative electrode including a negative active material, and an electrolyte including an organic solvent and a lithium salt.

According to still another embodiment, a rechargeable lithium battery includes the positive electrode, the negative electrode including the negative active material, a separator between the positive electrode and the negative electrode, an electrolyte including an organic solvent and a lithium salt, and a battery case. The volume of the battery case taken up by the positive electrode, the negative electrode, and the separator is about 80 volume % to 100 volume % based on 100 volume % of the battery case.

The positive electrodes exhibit rapid input and output characteristics at high rates, and may provide rechargeable lithium batteries exhibiting good cycle-life characteristics.

### BRIEF DESCRIPTION OF THE DRAWINGS

FIG. 1 is a cross-sectional schematic view of a structure of rechargeable lithium battery cell according to one embodiment.

FIG. 2 is a graph comparing the voltage vs. number of cycles of the rechargeable lithium cells of Example 1 and Comparative Example 1.

### DETAILED DESCRIPTION OF THE INVENTION

Exemplary embodiments of this disclosure will hereinafter be described in detail. However, these embodiments are only exemplary, and this disclosure is not limited thereto.

A positive electrode according to one embodiment includes a current collector and a positive active mass layer on the current collector. The positive active mass layer includes a positive active material, active carbon, a conductive material and a binder. In rechargeable lithium batteries, the “active mass” generally refers to a mixture of an active material, a conductive material, and a binder, and in the present invention, the “active mass” refers to a mixture of the positive active material, the active carbon, the conductive material, and the binder.

The active mass density of the positive active mass layer (g/cc) and the thickness (μm) of the positive active mass layer may satisfy Equation 1.

0.02≦active mass density of the active mass layer(g/cc)/thickness of the active mass layer(μm)≦0.3 Equation 1

The ratio of the active mass density of the active mass layer and the thickness (μm) of the active mass layer may be about 0.025 to about 0.3, as represented by Equation 2 below. In another embodiment, the ratio of the active mass density of the active mass layer and the thickness (μm) of the active mass layer may be about 0.025 to about 0.2, as represented by Equation 3 below.

0.025≦active mass density of the active mass layer(g/cc)/thickness of the active mass layer(μm)≦0.3 Equation 2

0.025≦active mass density of the active mass layer(g/cc)/thickness of the active mass layer(μm)≦0.2 Equation 3

When the ratio of the active mass density of the positive active mass layer and the thickness of the positive active mass layer satisfy Equation 1, the resulting rechargeable lithium battery exhibits rapid input and output characteristics at high rates, and the desired capacity may be achieved.

In some embodiments, the active mass density of the active mass layer may be about 1.5 g/cc to about 4 g/cc. When the active mass density of the active mass layer falls within this range, the resulting battery exhibits improved capacity.

Furthermore, the thickness of the active mass layer may be about 10 μm to about 200 μm, and in another embodiment, the thickness may be about 30 μm to about 200 μm. When the thickness of the active mass layer is within these ranges, the resulting battery has suitable battery capacity and rapid input and output characteristics.

As a result, it is desirable that the active mass density and the thickness of the active mass layer satisfy Equation 1, and are included in the above ranges.

Generally, as the active mass density of the positive active mass increases, the capacity increases, but extremely high density may not be suitable. In particular, increases in the loading level (i.e., the amount of the positive active material per unit area) may cause deterioration of the output characteristics. Furthermore, as the thickness of the active mass layer decreases, the input and output characteristics at high rates may be improved, but extremely low thickness causes capacity fading. Thus, in some embodiments of the present invention, the active mass density and the thickness of the active mass layer are suitably controlled to satisfy Equation 1, to thereby improve the capacity and input and output characteristics at high rates.

According to some embodiments, the positive electrode for a rechargeable lithium battery may be effectively used as a battery for ISG (idle stop and go) in vehicles with increased gas mileage and reduced CO₂ output. In general, batteries for ISG are those which shut off the engine when the car is stopped, and start the engine again when needed. These batteries should have very rapid reaction speeds since stopping or starting the car must occur in a short time-frame. Furthermore, these batteries should generally maintain the full-charge state while driving, and should have good power characteristics at low temperatures.

The positive electrode according to one embodiment of the present invention includes an active mass together with the positive active material in the positive active mass layer. This enables realization of both the advantages of a rechargeable lithium battery and the advantages of super capacity, thereby providing a battery exhibiting rapid input and output current characteristics and long cycle-life characteristics. Furthermore, since the active mass density and the thickness of the positive active mass layer satisfy Equation 1, the battery may exhibit rapid input and output characteristics at high rates and high capacity.

The positive active material may include a compound that reversibly intercalates and deintercalates lithium (i.e., a lithiated intercalation compound). For example, a composite oxide of at least one of cobalt, manganese, nickel, or a combination thereof, and lithium may be used. Nonlimiting examples of suitable compounds include those represented by the following formulae:

LiₐA_{1-b}X_{b}D₂ (0.90≦a≦1.8, 0≦b≦0.5)
LiₐA_{1-b}X_{b}O_{2-c}D_{c} (0.90≦a≦1.8, 0≦b≦0.5, 0≦c≦0.05)
LiₐE_{1-b}X_{b}O_{2-c}D_{c} (0≦b≦0.5, 0≦c≦0.05)
LiₐE_{2-b}X_{b}O_{4-c}D_{c} (0≦b≦0.5, 0≦c≦0.05)
LiₐNi_{1-b-c}Co_{b}X_{c}D_{α} (0.90≦a≦1.8, 0≦b≦0.5, 0≦c≦0.5, 0<α≦2)
LiₐNi_{1-b-c}Co_{b}X_{c}O_{2-α}T_{α} (0.90≦a≦1.8, 0≦b≦0.5, 0≦c≦0.05, 0<α<2)
LiₐNi_{1-b-c}Co_{b}X_{c}O_{2-α}T₂ (0.90≦a≦1.8, 0≦b≦0.5, 0≦c≦0.05, 0<α<2)
LiₐNi_{1-b-c}Mn_{b}X_{c}D_{α} (0.90≦a≦1.8, 0≦b≦0.5, 0≦c≦0.05, 0<α≦2)
LiₐNi_{1-b-c}Mn_{b}X_{c}O_{2-α}T_{α} (0.90≦a≦1.8, 0≦b≦0.5, 0≦c≦0.05, 0<α<2)
LiₐNi_{1-b-c}Mn_{b}X_{c}O_{2-α}T₂ (0.90≦a≦1.8, 0≦b≦0.5, 0≦c≦0.05, 0<α<2)
LiₐNi_{b}E_{c}G_{d}O₂ (0.90≦a≦1.8, 0≦b≦0.9, 0≦c≦0.5, 0.001≦d≦0.1)
LiₐNi_{b}Co_{c}Mn_{d}GₑO₂ (0.90≦a≦1.8, 0≦b≦0.9, 0≦c≦0.5, 0≦d≦0.5, 0.001≦e≦0.1)
LiₐNiG_{b}O₂ (0.90≦a≦1.8, 0.001≦b≦0.1)
LiₐCoG_{b}O₂ (0.90≦a≦1.8, 0.001≦b≦0.1)
LiₐMn_{1-b}G_{b}O₂ (0.90≦a≦1.8, 0.001≦b≦0.1)
LiₐMn₂G_{b}O₄ (0.90≦a≦1.8, 0.001≦b≦0.1)
LiₐMn_{1-g}G_{g}PO₄ (0.90≦a≦1.8, 0≦g≦0.5)

### QO₂

### QS₂

### LiQS₂

### V₂O₅

### LiV₂O₅

### LiZO₂

### LiNiVO₄

Li_{(3-f)}J₂(PO₄)₃ (0≦f≦2)
Li_{(3-f)}Fe₂(PO₄)₃ (0≦f≦2)
LiₐFePO₄ (0.90≦a≦1.8)

In the above formulae, A is selected from Ni, Co, Mn, and combinations thereof; X is selected from Al, Ni, Co, Mn, Cr, Fe, Mg, Sr, V, rare earth elements, and combinations thereof; D is selected from O, F, S, P, and combinations thereof; E is selected from Co, Mn, and combinations thereof; T is selected from F, S, P, and combinations thereof; G is selected from Al, Cr, Mn, Fe, Mg, La, Ce, Sr, V, and combinations thereof; Q is selected from Ti, Mo, Mn, and combinations thereof; Z is selected from Cr, V, Fe, Sc, Y, and combinations thereof; and J is selected from V, Cr, Mn, Co, Ni, Cu, and combinations thereof.

The positive active material compound may have a coating layer on the surface, or may be mixed with another compound having a coating layer. The coating layer may include at least one coating element compound selected from oxides of a coating element, hydroxides of a coating element, oxyhydroxides of a coating element, oxycarbonates of a coating element, and hydroxyl carbonates of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed by any suitable method so long is it does not have an adverse influence on the properties of the positive active material. For example, the method may include any coating method, such as spray coating, dipping, or the like. These coating methods are known to those of ordinary skill in the art.

In the positive active mass layer, the total amount of the positive active material and active carbon make up about 85 wt % to about 98 wt % of the positive active mass layer based on the total weight of the positive active mass layer. In the positive 85 wt % to 98 wt % of the active mass layer that is the positive active material and the active carbon, the mixing ratio of the positive active material to the active carbon may be about 80:20 to about 90:10 weight ratio.

Furthermore, each of the binder and the conductive material may be included in an amount ranging from about 1 wt % to about 10 wt % based on the total weight of the positive active mass layer. The binder improves the binding properties of the positive active material particles to each other and to the current collector. Nonlimiting examples of the binder include polyvinyl alcohol, carboxymethyl cellulose, hydroxypropyl cellulose, diacetyl cellulose, polyvinyl chloride, carboxylated polyvinyl chloride, polyvinyl fluoride, ethylene oxide-containing polymers, polyvinylpyrrolidone, polyurethane, polytetrafluoroethylene, polyvinylidene fluoride, polyethylene, polypropylene, styrene-butadiene rubbers, acrylated styrene-butadiene rubbers, epoxy resins, nylon, and the like.

The conductive material provides the electrode with conductivity. Any electrically conductive material may be used as the conductive material so long as it does not cause a chemical change. Nonlimiting examples of the conductive material include carbon-based materials such as natural graphite, artificial graphite, carbon black, acetylene black, ketjen black, carbon fibers, and the like; metal-based materials such as metal powders or metal fibers including copper, nickel, aluminum, silver, and the like; conductive polymers such as polyphenylene derivatives; and mixtures thereof.

The current collector may be Al, but is not limited thereto.

The positive electrode may be fabricated by mixing the positive active material, the active carbon, the conductive material, and the binder in a solvent to prepare an active mass composition, and coating the active mass composition on the current collector. The solvent may be N-methylpyrrolidone, but is not limited thereto.

According to another embodiment of the present invention, a rechargeable lithium battery includes the positive electrode, a negative electrode including a negative active material and an electrolyte. The rechargeable lithium battery may include a separator between the positive electrode and the negative electrode, and may also include a battery case. That is, a rechargeable lithium battery according to one embodiment includes the positive electrode, the separator, the negative electrode, and the electrolyte positioned in the battery case.

The positive electrode, the separator and the negative electrode may be spiral-wound to form a jellyroll shape. The volume of the jellyroll (i.e., the volume of the positive electrode, the separator, and the negative electrode) may take up about 80 volume % to 100 volume % of the battery case based on the total volume of the battery case. That is, the packing ratio may be 80 volume % to 100 volume %. In the specification, the total volume of the battery case refers to the volume before assembling the battery, or the total volume of the battery case after increases due to initial charge and discharge (e.g., the volume of the case may increase to about 105 volume % based on 100 volume % of the initial volume of the battery case prior to charging/discharging).

When the packing ratio falls within the above ranges, it is possible to fabricate batteries with optimum capacity, and shaking of the jellyroll within the battery case may be effectively suppressed, thereby preventing damage to the jellyroll and deterioration of battery performance.

The negative electrode includes a current collector and a negative active mass layer, i.e., a negative active material layer, disposed on the current collector. The negative active material layer includes a negative active material.

The negative active material includes a material that reversibly intercalates/deintercalates lithium ions, lithium metal, a lithium metal alloy, a material capable of doping/dedoping lithium, or a transition metal oxide.

The material that can reversibly intercalate/deintercalate lithium ions may include a carbonaceous material. The carbonaceous material may be any carbon-based negative active material that is generally used in lithium ion rechargeable batteries. Nonlimiting examples of the carbon material include crystalline carbon, amorphous carbon, and mixtures thereof. The crystalline carbon may be non-shaped, or sheet-, flake-, spherical-, or fiber-shaped natural or artificial graphite. The amorphous carbon may be a soft carbon, a hard carbon, a mesophase pitch carbonized product, fired coke, or the like.

Nonlimiting examples of the lithium metal alloy include alloys of lithium and an element selected from Na, K, Rb, Cs, Fr, Be, Mg, Ca, Sr, Si, Sb, Pb, In, Zn, Ba, Ra, Ge, Al, and/or Sn. The material capable of doping/dedoping lithium may include Si, a Si—C composite, SiOₓ (0<x<2), a Si-Q alloy (where Q is an element selected from alkali metals, alkaline-earth metals, Group 13 elements, Group 14 elements, Group 15 elements, Group 16 elements, transition elements, rare earth elements, and combinations thereof, but Q is not Si), Sn, SnO₂, a Sn—R alloy (where R is an element selected from alkali metals, alkaline-earth metals, Group 13 elements, Group 14 elements, Group 15 elements, Group 16 elements, transition elements, rare earth elements, and combinations thereof, but R is not Sn), and the like. At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and combinations thereof.

The transition metal oxide may include vanadium oxide, lithium vanadium oxide, or the like.

In the negative active material layer, the negative active material may be included in an amount of about 95 wt % to about 99 wt % based on the total weight of the negative active material layer.

The negative active material layer may include a binder, and optionally a conductive material. The negative active material layer may include about 1 wt % to about 5 wt % of the binder based on the total weight of the negative active material layer. When the negative active material layer includes a conductive material, the negative active material layer includes about 90 wt % to about 98 wt % of the negative active material, about 1 wt % to about 5 wt % of the binder, and about 1 wt % to about 5 wt % of the conductive material.

The binder improves the binding properties of negative active material particles with one another and with the current collector. The binder may include a non-water-soluble binder, a water-soluble binder, or a combination thereof.

Nonlimiting examples of the non-water-soluble binder include polyvinylchloride, carboxylated polyvinylchloride, polyvinyl fluoride, ethylene oxide-containing polymers, polyvinylpyrrolidone, polyurethane, polytetrafluoroethylene, polyvinylidene fluoride, polyethylene, polypropylene, polyamideimide, polyimide, and combinations thereof.

Nonlimiting examples of the water-soluble binder include styrene-butadiene rubbers, acrylated styrene-butadiene rubbers, polyvinyl alcohol, sodium polyacrylate, copolymers of propylene and a C2 to C8 olefin, copolymers of (meth)acrylic acid and (meth)acrylic acid alkyl ester, and combinations thereof.

When a water-soluble binder is used as the negative electrode binder, a cellulose-based compound may also be included to provide viscosity. The cellulose-based compound may include one or more of carboxymethyl cellulose, hydroxypropylmethyl cellulose, methyl cellulose, and alkali metal salts thereof. The alkali metal may be Na, K, or Li. The cellulose-based compound may be included in an amount of about 0.1 to about 3 parts by weight based on 100 parts by weight of the negative active material.

The conductive material is included to provide electrode conductivity. Any electrically conductive material may be used as a conductive material so long as it does not cause a chemical change. Nonlimiting examples of the conductive material include carbon-based materials such as natural graphite, artificial graphite, carbon black, acetylene black, ketjen black, carbon fibers, and the like; metal-based materials such as metal powders or metal fibers including copper, nickel, aluminum, silver, and the like; conductive polymers such as polyphenylene derivatives; and mixtures thereof.

Nonlimiting examples of the current collector include copper foils, nickel foils, stainless steel foils, titanium foils, nickel foams, copper foams, polymer substrates coated with a conductive metal, and combinations thereof.

The negative electrode may be fabricated by mixing the negative active material, the binder, and optionally the conductive material to prepare an active material composition, and coating the composition on a current collector. The electrode-manufacturing method is well known. The solvent may include N-methylpyrrolidone or the like, but is not limited thereto. When the negative electrode includes a water-soluble binder, the negative active material composition may use water as a solvent.

The electrolyte includes an organic solvent and a lithium salt. The organic solvent serves as a medium for transmitting ions taking part in the electrochemical reactions of the battery. The organic solvent may include a carbonate-based, ester-based, ether-based, ketone-based, alcohol-based, or aprotic solvent.

Nonlimiting examples of the carbonate-based solvent include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

Nonlimiting examples of the ester-based solvent include methyl acetate, ethyl acetate, n-propyl acetate, methylpropionate, ethylpropionate, γ-butyrolactone, decanolide, valerolactone, mevalonolactone, caprolactone, and the like.

Nonlimiting examples of the ether-based solvent include dibutyl ether, tetraglyme, diglyme, dimethoxyethane, 2-methyltetrahydrofuran, tetrahydrofuran, and the like.

Nonlimiting examples of the ketone-based solvent include cyclohexanone, and the like.

Nonlimiting examples of the alcohol-based solvent include ethyl alcohol, isopropyl alcohol, and the like.

Nonlimiting examples of the aprotic solvent include nitriles such as R—CN (where R is a C2 to C20 linear, branched, or cyclic hydrocarbon group including a double bond, an aromatic ring, or an ether bond), amides such as dimethylformamide, dioxolanes such as 1,3-dioxolane, sulfolanes, and the like.

A single organic solvent may be used, or a mixture of organic solvents may be used. When a mixture of organic solvents is used, the mixture ratio can be controlled in accordance with the desired battery performance.

The carbonate-based solvent may include a mixture of a cyclic carbonate and a linear carbonate. The cyclic carbonate and the linear carbonate may be mixed together in a volume ratio of about 1:1 to about 1:9. When the cyclic and linear carbonates are mixed within this range, electrolyte performance may be improved.

The organic electrolyte may include a carbonate-based solvent and an aromatic hydrocarbon-based solvent. The carbonate-based and the aromatic hydrocarbon-based solvents may be mixed together in a volume ratio ranging from about 1:1 to about 30:1.

The aromatic hydrocarbon-based organic solvent may be represented by the following Chemical Formula 1.

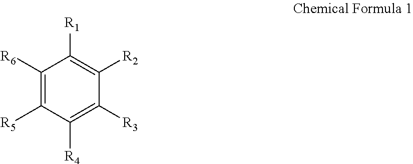

In Chemical Formula 1, R₁ to R₆ are each independently selected from hydrogen, halogens, C1 to C10 alkyl groups, C1 to C10 haloalkyl groups, and combinations thereof.

Nonlimiting examples of the aromatic hydrocarbon-based organic solvent include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and combinations thereof. The non-aqueous electrolyte may further include vinylene carbonate, or an ethylene carbonate-based compound represented by the following Chemical Formula 2 to improve cycle-life.

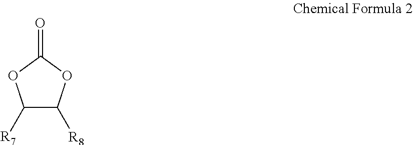

In Chemical Formula 2, R₇ and R₈ are each independently selected from hydrogen, halogens, cyano groups (CN), nitro groups (NO₂), and C1 to C5 fluoroalkyl groups, provided that at least one of R₇ and R₈ is selected from halogens, cyano groups (CN), nitro groups (NO₂), and C1 to C5 fluoroalkyl groups (i.e., at least one of R₇ and R₈ is not hydrogen).

Nonlimiting examples of the ethylene carbonate-based compound include difluoroethylene carbonate, chloroethylene carbonate, dichloroethylene carbonate, bromoethylene carbonate, dibromoethylene carbonate, nitroethylene carbonate, cyanoethylene carbonate, fluoroethylene carbonate, and the like. The amount of the vinylene carbonate or the ethylene carbonate-based compound used to improve cycle life may be adjusted within an appropriate range.

The electrolyte may also include a borate-based compound as an additive for improving power characteristics. The borate-based compound may be tris(trimethylsilyl borate) (TMSB), etc., but is not limited thereto. The amount of the borate-based compound may be suitably controlled.

The lithium salt is dissolved in an organic solvent, supplies the lithium ions in the battery, enables the basic operation of the rechargeable lithium battery, and improves lithium ion transportation between the positive and negative electrodes. Nonlimiting examples of the lithium salt include supporting electrolytic salts such as LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers and are integers of 1 to 20), LiCl, LiI, LiB(C₂O₄)₂ (lithium bis(oxalato) borate, LiBOB), and combinations thereof. The lithium salt may be included in a concentration of about 0.1 M to about 2.0 M. When the lithium salt is included in concentration within this range, the electrolyte may have good performance and lithium ion mobility due to optimal electrolyte conductivity and viscosity.

The separator may include polyethylene, polypropylene, polyvinylidene fluoride, or a multilayered separator of two or more layers thereof. The separator may also include a mixed multilayer such as a polyethylene/polypropylene 2-layered separator, a polyethylene/polypropylene/polyethylene 3-layered separator, a polypropylene/polyethylene/polypropylene 3-layered separator, or the like.

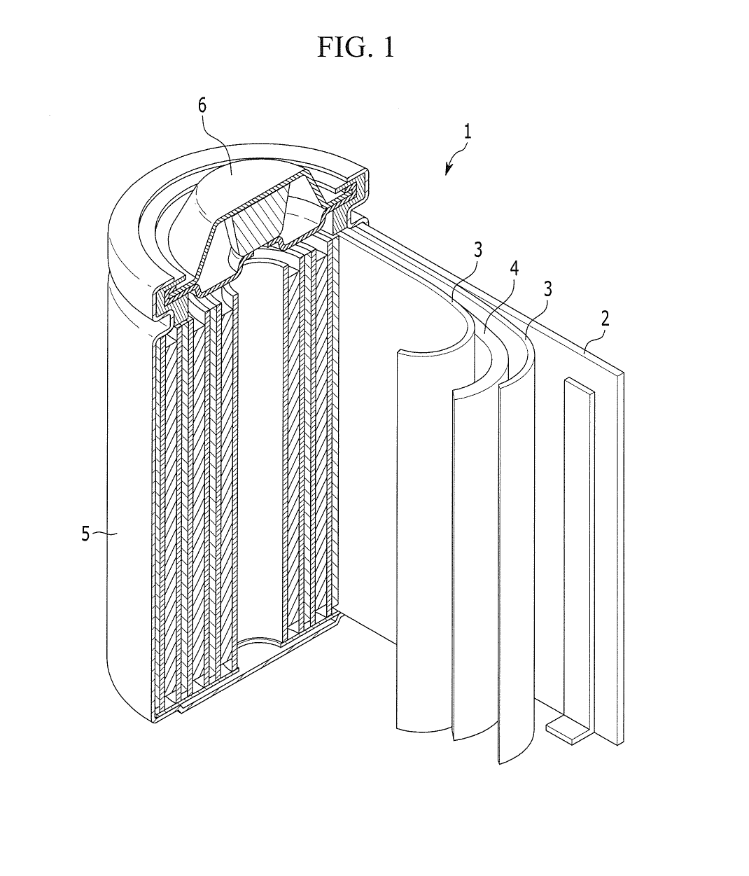

FIG. 1 is a cross-sectional schematic view of a representative structure of a rechargeable lithium battery according to embodiments of the present invention. As shown in FIG. 1, the rechargeable lithium battery 1 includes a positive electrode 2, a negative electrode 4, and a separator 3 between the positive electrode 2 and negative electrode 4. A battery case 5 and a sealing member 6 seal the battery case 5, and an electrolyte is injected therein.

The following examples are presented for illustrative purposes only, and do not limit the scope of the present invention.

### Example 1

85 wt % of LiCoO₂, 5 wt % of active carbon, 4 wt % of denka black, 6 wt % of polyvinylidene fluoride (product name: Solef 6020, manufacturer: Solvay) were mixed in an N-methylpyrrolidone solvent to prepare a positive active material slurry.

The positive active material slurry was coated on an Al foil to a thickness of 15 μm, dried at 100° C., and then pressed to fabricate a positive electrode with an active mass layer (positive active material layer) having an active mass density of 2.6 g/cc. The thickness of the active mass layer was 35 μm. Thus, the ratio of the active mass density of the active mass layer to the thickness of the layer was about 0.074.

92 wt % of soft carbon, 5 wt % of denka black, and 3 wt % of a mixture of styrene-butadiene rubber and carboxymethyl cellulose (2:1 weight ratio) were mixed in a water solvent to prepare a negative active material slurry.

The negative active material slurry was coated on a Cu foil to a thickness of 10 μm, dried at 100° C., and then pressed to fabricate a negative electrode with an active mass layer (negative active material layer) having an active mass density of about 1 g/cc, and having a loading level (L/L) of about 4.95 g/cc.

A separator was inserted between the positive and negative electrodes, and the resulting assembly was wound in the form of a cylinder to produce a jellyroll shape. As the separator, a 3-layer film of polyethylene/polypropylene/polyethylene having a thickness of 25 μm was used.

The obtained jellyroll was placed into an 18650-size battery case, and 50 g of an electrolyte was injected therein to fabricate a rechargeable lithium cell. The electrolyte was prepared by adding 0.5 wt % of tris(trimethylsilyl borate) to 1.15 M LiPF₆ dissolved in a mixed solution of ethylene carbonate, ethylmethyl carbonate, and dimethyl carbonate (2:4:4 volume ratio). The volume of the jellyroll (positive electrode, negative electrode and separator) was set to about 92 volume % to about 94 volume % of the battery case based on 100 volume % of the battery case.

### Example 2

85 wt % of LiNi_{1/3}Co_{1/3}Mn_{1/3}O₂, 5 wt % of active carbon, 4 wt % of denka black, 6 wt % of polyvinylidene fluoride (product name: Solef 6020, manufacturer: Solvay) were mixed in an N-methylpyrrolidone solvent to prepare a positive active material slurry.

The positive active material slurry was coated on an Al foil with a thickness of 15 μm, dried at 100° C., and then pressed to fabricate a positive active electrode with an active mass layer (positive active material layer) having an active mass density of 2.4 g/cc. The thickness of the active mass layer was 40 μm. Thus, the ratio of the active mass density of the active mass layer/the thickness was about 0.06.

92 wt % of soft carbon, 5 wt % of denka black, and 3 wt % of a mixture of styrene-butyrene rubber and carboxymethyl cellulose (2:1 weight ratio) were mixed in a water solvent to prepare a negative active material slurry.

The negative active material slurry was coated on a Cu foil with a thickness of 10 μm, dried at 100° C., and then pressed to fabricate a negative electrode with an active mass layer (negative active material layer) having an active mass density of about 1 g/cc, and having a loading level (L/L) of about 4.95 g/cc.

A separator was inserted between the positive and negative electrodes, and the resultant was wound in the form of a cylinder type, to produce a jellyroll shape. As the separator, a 3-layer film of polyethylene/polypropylene/polyethylene having a thickness of 25 μm was used.

The obtained jellyroll was put into an 18650-size battery case, and 50 g of an electrolyte was injected therein, to fabricate a rechargeable lithium cell. As the electrolyte, one in which 0.5 wt % of tris(trimethylsilyl borate) was added to 1.15 M LiPF₆ dissolved in a mixed solution of ethylene carbonate, ethylmethyl carbonate, and dimethyl carbonate (2:4:4 volume ratio) was used. At this time, the volume of the jellyroll (positive electrode, negative electrode and separator) was set to about 92 volume % to about 94 volume % based on the total of 100 volume % of the battery case.

### Example 3

85 wt % of LiFePO₄, 5 wt % of active carbon, 4 wt % of denka black, 6 wt % of polyvinylidene fluoride (product name: Solef 6020, manufacturer: Solvay) were mixed in an N-methylpyrrolidone solvent to prepare a positive active material slurry.

The positive active material slurry was coated on an Al foil with a thickness of 15 μm, dried at 100° C., and then pressed to fabricate a positive active electrode with an active mass layer (positive active material layer) having an active mass density of 1.9 g/cc. The thickness of the active mass layer was 45 μm. Thus, the ratio of the active mass density of the active mass layer/the thickness was about 0.042.

92 wt % of soft carbon, 5 wt % of denka black, and 3 wt % of a mixture of styrene-butyrene rubber and carboxymethyl cellulose (2:1 weight ratio) were mixed in a water solvent to prepare a negative active material slurry.

The negative active material slurry was coated on a Cu foil with a thickness of 10 μm, dried at 100° C., and then pressed to fabricate a negative electrode with an active mass layer (negative active material layer) having an active mass density of about 1 g/cc, and having a loading level (L/L) of about 5.94 g/cc.

A separator was inserted between the positive and negative electrodes, and the resultant was wound in the form of a cylinder type, to produce a jellyroll shape. As the separator, a 3-layer film of polyethylene/polypropylene/polyethylene having a thickness of 25 μm was used.

The obtained jellyroll was put into an 18650-size battery case, and 50 g of an electrolyte was injected therein, to fabricate a rechargeable lithium cell. As the electrolyte, one in which 0.5 wt % of tris(trimethylsilyl borate) was added to 1.15 M LiPF₆ dissolved in a mixed solution of ethylene carbonate, ethylmethyl carbonate, and dimethyl carbonate (2:4:4 volume ratio) was used. At this time, the volume of the jellyroll (positive electrode, negative electrode and separator) was set to about 92 volume % to about 94 volume % based on the total of 100 volume % of the battery case.

### Comparative Example 1

A rechargeable lithium cell was fabricated as in Example 1, except that the positive active material slurry produced in Example 1 was coated on an Al foil to a thickness of 15 μm, dried, and then pressed to fabricate a positive electrode with an active mass layer (positive active material layer) having an active mass density of 2.6 g/cc and a thickness of the active mass layer of 200 μm. making the ratio of the active mass of the active mass layer to the thickness of the active mass layer about 0.013.

### Comparative Example 2

A rechargeable lithium cell was fabricated by the same procedure as in Example 1, except that the positive active material slurry produced in Example 3 was coated on an Al foil with a thickness of 15 μm, dried, and then pressed to fabricate a positive electrode with an active mass layer (positive active material layer) having an active mass density of 1.9 g/cc and a thickness of the active mass layer of 107 μm. In the positive electrode, the ratio of the active mass of the active mass layer/thickness of the active mass layer was about 0.018.

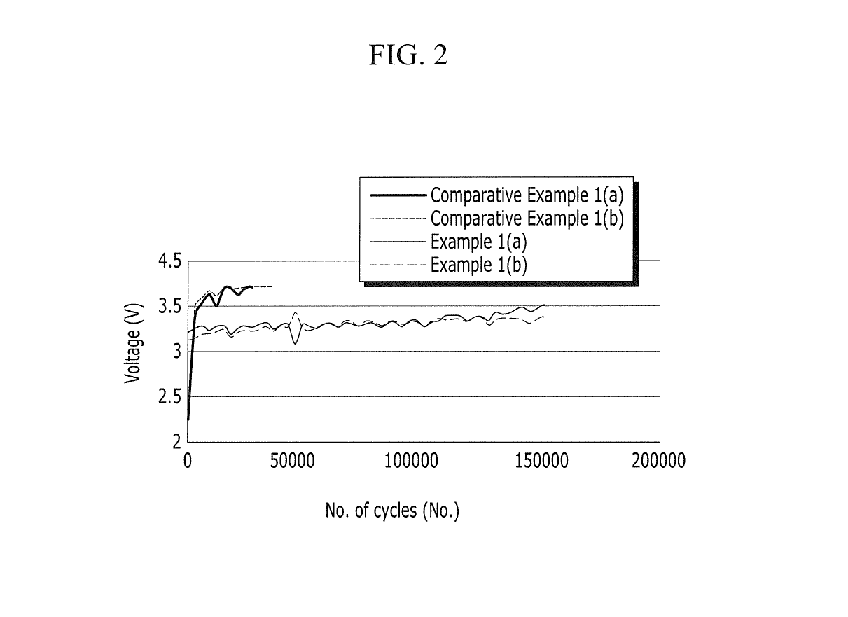

Two cells of each of Example 1 (i.e., Example 1(a) and Example 1(b)) and Comparative Example 1 (i.e., Comparative Example 1(a) and Comparative Example 1(b)) were charged and discharged at 30 C for 150,000 cycles, and the results are shown in FIG. 2.

While charging at high rates, a voltage reaching 4.2 V indicates the end of the cycle-life, i.e., where charge and discharge do not occur. As shown in FIG. 2, the rechargeable lithium cells according to Example 1 (i.e., Example 1(a) and Example 1(b)) did not reach 4.2 V even though charge and discharge were performed 150,000 times (i.e., 150,000 cycles). These results show that the cells according to Example 1 are better able to maintain cycle-life. However, the cells according to Comparative Example 1 (i.e., Comparative Example 1(a) and Comparative Example 1(b)) reached 4.2 V at the 30,000^{th} charge and discharge cycle, indicating the end of the cycle-life occurred at 30,000 cycles. Thus, the rechargeable lithium cells according to Example 1 exhibited surprisingly improved cycle-life characteristics, as compared to the cells according to Comparative Example 1.

Two cells in each of Examples 1 to 3 and Comparative Example 2 were charged and discharged while the C-rate was varied, i.e., charged and discharged at 1 C, 10 C, 30 C, and 50 C, once at the C-rate. The discharge capacity was measured and the results are shown in Table 1. Furthermore, the charge capacity was measured and the results are shown in Table 2. Furthermore, the ratios of the discharge capacity at 50 C to the discharge capacity at 1 C are shown in Table 1, and the ratios of the charge capacity at 50 C to the charge capacity at 1 C are shown in Table 2.

TABLE 1

| Discharge | 1 C[Ah] | 10 C[Ah] | 30 C[Ah] | 50 C[Ah] | 50 C/1 C(%) |
|---|---|---|---|---|---|
| Example 1 | 4.1 | 3.9 | 3.8 | 3.7 | 92 |
| Example 1 | 4.1 | 3.9 | 3.8 | 3.7 | 92 |
| Example 2 | 4.0 | 3.8 | 3.7 | 3.6 | 91 |
| Example 2 | 4.0 | 3.8 | 3.7 | 3.6 | 91 |
| Example 3 | 3.2 | 3.1 | 2.9 | 2.8 | 87 |
| Example 3 | 3.2 | 3.1 | 2.9 | 2.8 | 87 |
| Comparative | 3.9 | 3.1 | 2.6 | 1.4 | 37 |
| Example 2 | | | | | |
| Comparative | 3.9 | 3.1 | 2.6 | 1.4 | 38 |
| Example 2 | | | | | |

TABLE 2

| Charge | 1 C[Ah] | 10 C[Ah] | 30 C[Ah] | 50 C[Ah] | 50 C/1 C(%) |
|---|---|---|---|---|---|
| Example 1 | 4.0 | 3.7 | 3.3 | 2.9 | 72 |
| Example 1 | 4.0 | 3.7 | 3.3 | 2.9 | 72 |
| Example 2 | 3.9 | 3.7 | 3.4 | 3.1 | 80 |
| Example 2 | 3.9 | 3.7 | 3.4 | 3.1 | 80 |
| Example 3 | 3.2 | 3.0 | 2.8 | 2.6 | 80 |
| Example 3 | 3.2 | 3.0 | 2.8 | 2.6 | 81 |
| Comparative | 3.8 | 2.9 | 2.4 | 1.4 | 37 |
| Example 2 | | | | | |
| Comparative | 3.8 | 2.9 | 2.4 | 1.4 | 37 |
| Example 2 | | | | | |

As shown in Tables 1 and 2, the rechargeable lithium cells according to Examples 1 to 3 exhibited good charge and discharge characteristics at high rates, compared to that according to Comparative Example 2.

While the present invention has been illustrated and described in connection with certain exemplary embodiments, those of ordinary skill in the art would understand that various modifications may be made to the described embodiments without departing from the spirit and scope of the present invention, as defined in the appended claims.

What is claimed is:

1. A positive electrode for a rechargeable lithium battery, comprising:
a current collector; and
a positive active mass layer on the current collector, the positive active mass layer comprising a positive active material, active carbon, a conductive material, and a binder, the positive active mass layer having a positive active mass density and a thickness satisfying Equation 1:
0.02≦active mass density(g/cc)/thickness(μm)≦0.3. Equation 1

2. The positive electrode of claim 1, wherein the positive active mass density and the thickness of the positive active mass layer satisfy Equation 2:
0.025≦active mass density(g/cc)/thickness(μm)≦0.3. Equation 2

3. The positive electrode of claim 1, wherein the positive active mass density and the thickness of the positive active mass layer satisfy Equation 3:
0.025≦active mass density(g/cc)/thickness(μm)≦0.2. Equation 3

4. The positive electrode of claim 1, wherein the positive active mass density of the positive active mass layer is about 1.5 g/cc to about 4 g/cc.

5. The positive electrode of claim 1, wherein the thickness of the positive active mass layer is about 10 μm to about 200 μm.

6. The positive electrode of claim 1, wherein the thickness of the positive active mass layer is about 30 μm to about 200 μm.

7. The positive electrode of claim 1, wherein the positive active material and the active carbon make up about 85 wt % to about 98 wt % of the positive active mass layer based on 100 wt % of the positive active mass layer.

8. The positive electrode of claim 7, wherein a ratio of the positive active material to the active carbon is about 80:20 to about 90:10 weight ratio.

9. The positive active material of claim 1, wherein each of the binder and the conductive material is present in an amount of about 1 wt % to about 10 wt % based on a total weight of the positive active mass layer.

10. A rechargeable lithium battery, comprising:
the positive electrode of claim 1;
a negative electrode comprising a negative active material; and
an electrolyte.

11. The rechargeable lithium battery of claim 10, wherein the positive active mass density and the thickness of the positive active mass layer satisfy Equation 2:
0.025≦active mass density(g/cc)/thickness(μm)≦0.3. Equation 2

12. The rechargeable lithium battery of claim 10, wherein the positive active mass density and the thickness of the positive active mass layer satisfy Equation 3:
0.025≦active mass density(g/cc)/thickness(μm)≦0.2. Equation 3

13. The rechargeable lithium battery of claim 10, wherein the positive active mass density of the positive active mass layer is about 1.5 g/cc to about 4 g/cc.

14. The rechargeable lithium battery of claim 10, wherein the thickness of the positive active mass layer is about 10 μm to about 200 μm.

15. The rechargeable lithium battery of claim 10, wherein the thickness of the positive active mass layer is about 30 μm to about 200 μm.

16. The rechargeable lithium battery of claim 10, further comprising:
a separator between the positive electrode and the negative electrode, and
a battery case,
wherein the positive electrode, the negative electrode and the separator occupy about 80 vol % to about 100 vol % of the battery case based on 100 vol % of the battery case.

17. The rechargeable lithium battery of claim 10, wherein the positive active material and the active carbon make up about 85 wt % to about 98 wt % of the positive active mass layer based on 100 wt % of the positive active mass layer.

18. The rechargeable lithium battery of claim 17, wherein a ratio of the positive active material to the active carbon is about 80:20 to about 90:10 weight ratio.

19. The rechargeable lithium battery of claim 10, wherein each of the binder and the conductive material is present in an amount of about 1 wt % to about 10 wt % based on a total weight of the positive active mass layer.
